(19) United States
(12) Patent Application Publication
(10) Pub. No.: US 2009/0240565 A1
(43) Pub. Date: Sep. 24, 2009

(54) Online system and method for property rental transactions, property management, and assessing performance of landlords and tenants

(76) Inventor: Jerry Calonge, New York, NY (US)

Correspondence Address: Janine D. Geraigery, Esq.;Law Offices of J.D. Geraigery, P.C., 44th Floor, 570 Lexington Ave., New York, NY, 10022, US

(21) Appl. No.: 12/381,956

(22) Filed: Mar. 18, 2009

Related U.S. Application Data
(60) Provisional application No. 61/069,861, filed on Mar. 18, 2008.

(51) Int. Cl. G06Q 10/00; G06Q 30/00; G06Q 40/00; G06F 17/40; G06F 17/30; G06Q 50/00; G06Q 20/00

(52) U.S. Cl. 705/10; 705/27; 705/34; 705/40; 707/3; 707/104.1; 707/E17.014; 707/E17.044

(57) ABSTRACT

An online system and method for tenants and landlords to conduct property rental transactions and property management, while simultaneously assessing the performance of landlords and tenants in an online environment.

### CROSS-REFERENCE TO RELATED APPLICATION

This application is a continuation of provisional patent application Ser. No. 61/069,861 filed in the United States Patent and Trademark Office on Mar. 18, 2008.

### BACKGROUND OF THE INVENTION

### Field of the Invention

The invention relates to online services, and more particularly to an online system and method for business and individual users to conduct property rental transactions and property management, while simultaneously assessing the performance of landlords and tenants in an online environment.

The property rental process can be arduous and time consuming. Potential tenants must often travel to realtor offices, management companies, or the rental property itself to view some of the features of the property and to submit their credit or rental history. Landlords are also plagued with the inconvenience of traveling to the property and managing long-distance paper submissions, including credit histories, rental applications, leases, and rental payments. In addition, potentials tenants may be relocating from another state and landlords may not reside in the same city or state as the properties they manage. The geographical gap between potential tenants, landlords and the properties of interest subsequently hinders the efficiency of timely property rentals.

Compounding the hassle of managing several properties at one time or searching for attractive rental properties is the stress of deciding who to rent to or rent from. Traditionally, landlords are not given any information regarding the applicant's performance as a tenant, but must instead base their selections strictly off the applicant's income or credit score. Potential tenants, on the other hand, lack any sort of resource for which they can assess the performance of landlords.

With its growing development and greater accessibility, the Internet has become a necessary tool in business. However, the facilitation of property transactions and the assessment of landlords and tenants have yet to embrace the electronic domain. The current invention seeks to eliminate that dilemma by creating a method which unifies the property rental, management, and landlord and tenant evaluation processes into one convenient online system.

While these units may be suitable for the particular purpose employed, or for general use, they would not be as suitable for the purposes of the present invention as disclosed hereafter.

### SUMMARY OF THE INVENTION

It is an object of the invention to provide a unified property rental, management, and landlord and tenant evaluation system. The present invention is an online system having a plurality of interfaces which allow parties to engage in business and residential property rental transactions and management, while simultaneously assessing the performance of landlords and tenants.

It is another object of the invention to provide an online system that allows landlords, tenants and third party vendors to access and exchange information derived from a property listing, tenant listing and score listings through a secure network. The system incorporates a database that stores, analyzes, and delivers information about tenants, landlords and rental properties to pre-determined parties.

It is another object of the invention to provide a secure landlord interface to allow landlords to engage in property management. The landlords may oversee and manage multiple properties of differing locations and varying statuses, including those that are vacant, occupied or in the process of being leased by a potential tenant. The system also allows landlords to receive electronic remittance payments, manage the payment histories of current tenants, and manage the correspondence exchanged between the landlord and tenant.

It is another object of the invention to provide a secure tenant interface to allow tenants to search for available rentals and manage current rentals. The tenant may view business and residential property rental availability, manage their payment histories and submit remittance payments to current landlords.

It is another object of the invention to provide a rental system for all business and residential property rental transactions, which includes the advertisement of property rental availability.

It is another object of the invention to provide a third party vendor interface to allow authorized third party vendors to evaluate the rental history of tenants in interest.

It is another object of the invention to provide a landlord and tenant evaluation system that assesses the performance of participating landlords and tenants, and provides detailed reports of each party. The landlord and tenant evaluation system includes a proprietary scoring system that assesses the rental risk and viability of potential tenants.

It is another object of the invention to provide a controlled and secure business transaction system for all rental transactions. The business transaction system is password protected and contains a record of any and all parties involved in the search of a tenant's rental score.

It is yet another object of the invention to incorporate third party vendor information, such as management company data, into the system in order to generate a listing score, with score and report information for landlords and tenants.

An online system and method for tenants and landlords to conduct property rental transactions and property management, while simultaneously assessing the performance of landlords and tenants in an online environment.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the drawings, like elements are depicted by like reference numerals. The drawings are briefly described as follows.

FIG. 1 is a high-level block diagram illustrating the operation of a method and system of the present invention.

FIG. 2 is a block diagram illustrating the preferred interfaces of the server in communication with the database.

FIG. 3 is a block diagram of the preferred embodiment of the system exemplifying the flow of information between a client and the server, through a main user interface of the system.

FIG. 4 is a block diagram of the preferred embodiment of the system exemplifying the flow of information between a landlord and the server, through the landlord interface of the system.

FIG. 5 is a block diagram of the preferred embodiment of the system exemplifying the flow of information between a tenant and the server, through the tenant interface of the system.

FIG. 6 is a block diagram of the preferred embodiment of the system exemplifying the flow of information between an administrator and the server, through the administrator interface of the system.

FIG. 7 is a block diagram of the preferred embodiment of the system exemplifying the flow of information between a third party vendor and the server, through the third party vendor interface of the system.

### DETAILED DESCRIPTION OF THE PREFERRED EMBODIMENTS

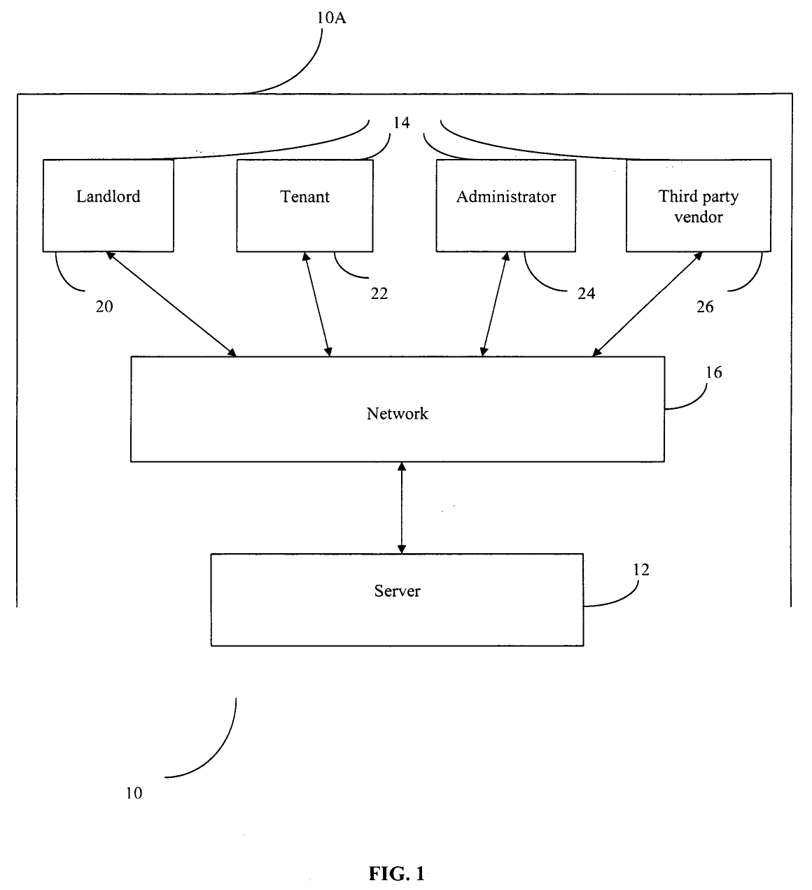

FIG. 1 is an online system and method 10 for business and individual users to conduct property rental transactions and property management, while simultaneously assessing the performance of landlords and tenants in an online environment.

In its broadest context the system 10 includes a client-server module 10A, including a server 12, in communication with a plurality of clients 14 by means of a network 16. The client-server module 10A facilitates leasing transactions over the online network 16. The clients 14 in this preferred module consists of a landlord 20, a tenant 22, an administrator 24, and a third party vendor 26. These clients 14 act as request senders by requesting data from the server 12 and waiting for a reply. The server 12 which is configured in communication with a database 18, acts as a receiver by waiting for the client's 14 request and then providing data to the client 14 based on the request. In the preferred embodiment, the server 12 is a World Wide Web server. The database 18 collects, stores and retrieves information from the server 12, and contains a plurality of records, including but not limited to, property listings 12A, tenant listings 12B and scores listing 12C.

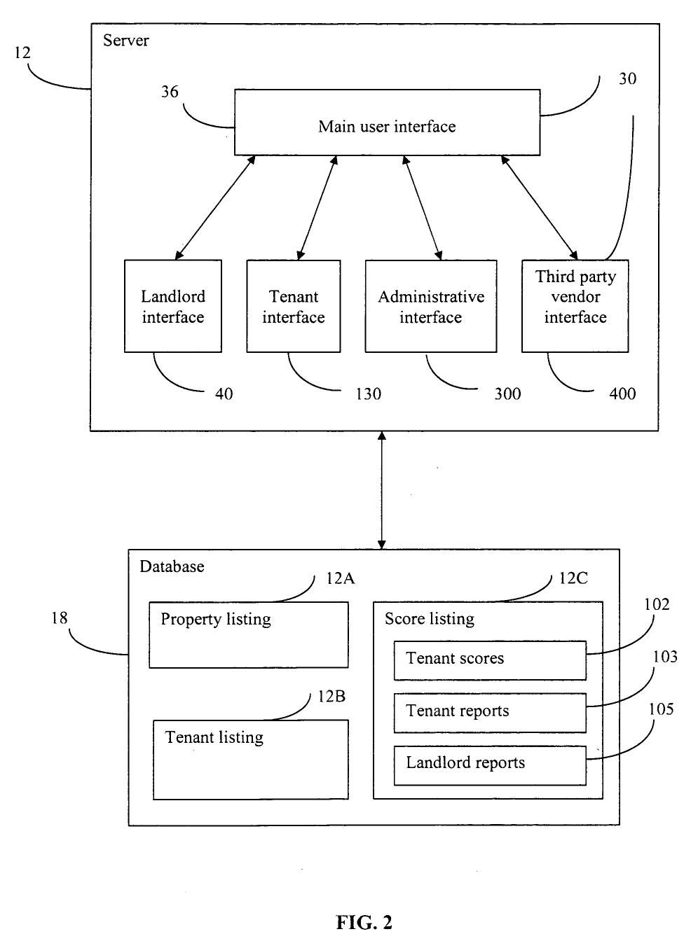

FIG. 2 is the server 12 configured in communication with the database 18. The server 12 contains a plurality of interfaces 30 including a main user interface 36, landlord interface 40, a tenant interface 130, an administrator interface 300, and a third party interface 400. The interfaces 30 of the server 12 facilitate communications between the server 12 and clients 14. The database 18 contains the property listing 12A, tenant listing 12B, and score listing 12C. The tenant reports 103 and tenant scores 102 created by landlords, and landlord reports 105 created by tenants, are further contained within the score listing 12C.

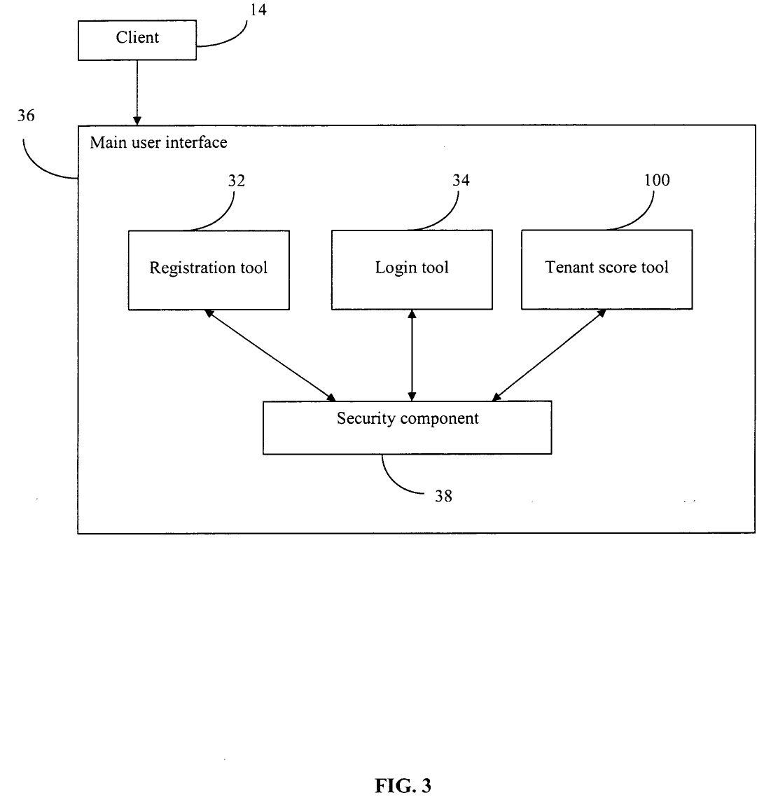

FIG. 3 illustrates the main user interface 36, which facilitates the transfer of information between the client 14 and the server 12. The main user interface 36 includes the registration tool 32, login tool 34 and tenant score tool 100. The main user interface 36 allows the client 14 to access the registration tool 32, login tool 34 or tenant score tool 100, and then directs the client 14 to the respective landlord interface 40, tenant interface 130, administrator interface 300, or third party interface 400. For example, a client 14 who accesses the registration tool 32 on the main user interface 36 to register as a landlord 20 will be directed to the landlord interface 40.

A registration tool 32 allows new clients 14 to begin using the system 10. The registration tool 32 is in communication with a landlord registration component 42 within the landlord interface 40, a tenant registration component 132 within the tenant interface 130, a third party registration component 402 within the third party interface 400, and an administrator registration component 302 within the administrator interface 300. The registration tool 32 is equipped with a security component 38 for ensuring the privacy of all information provided.

A login tool 34 allows existing clients 14 to use the system 10. In the preferred embodiment, the login tool 34 is in communication with the landlord login component 54, the tenant login component 150, the administrator login component 304, and the third party vendor login component 406. The login tool 34 receives the unique identification number and password entered by the landlord 20 and immediately recognizes by coding that the client 14 is a landlord 20 and directs the landlord 20 into the landlord interface 40. Thus, the landlord login component 54 of the login tool 34 allows landlords 20 to access the secure features of the landlord interface 40 through the generated unique identification number and password 52. Similarly, the unique identification number and password entered by every client 14, automatically allows the system 10 to direct that client 14 to their respective interface. The login tool 34 is equipped with a security component 38 for ensuring the privacy of all information provided.

A tenant score tool 100 allows the client 14 to access the score listing 12C from the database via a tenant score access component for landlords 104, tenant score access component for tenants 156, and tenant score access component for third parties 404. The tenant score 102 can range from thirty five point zero to ninety five point zero. The default tenant score 102 is forty five point zero and is assigned to new tenants 22 using the system 10. The tenant score tool 34 is equipped with a security component 38 for ensuring the privacy of all information provided.

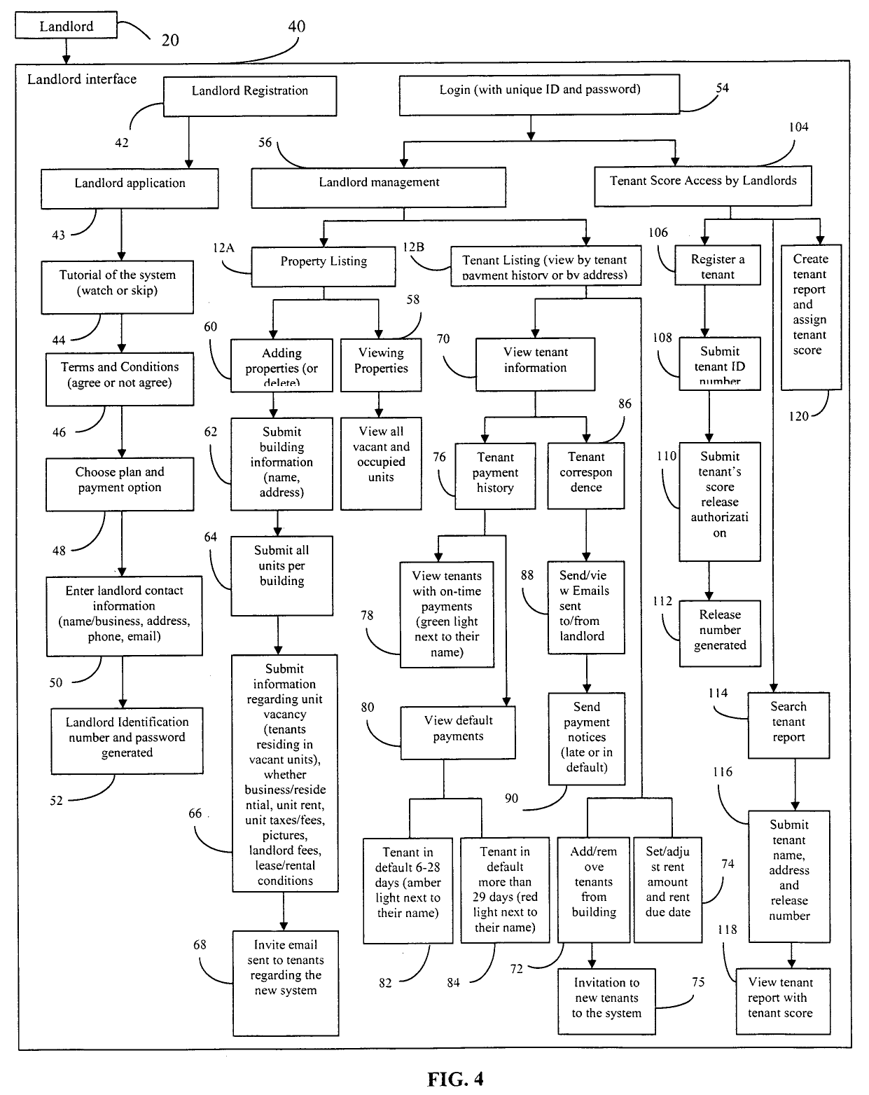

FIG. 4 illustrates the landlord interface 40, which facilitates the transfer of information between the landlord 20 and the server 12. In the preferred embodiment, the landlord 20 is a client 14 that is behaving in a contractual manner as a landlord.

The landlord interface 40 includes the landlord registration component 42 which allows new landlords 20 to register and then begin using the system 10. The landlord registration component 42 includes a plurality of different web pages for the landlord 20 to navigate through before a unique identification number and password is generated to allow the landlord 20 to login. The first page includes a landlord application 43 which must be completed by the potential landlord 20 and submitted. The landlord application 43 may also be completed over the telephone via a telephone representative. The next page of the landlord registration component 42 is a tutorial of the system 44, which the landlord 20 can watch as a video or read as a file. The next page is terms and conditions 46, which the landlord 20 must either agree to or not agree to. If the landlord 20 does not agree to the terms and conditions 46, the landlord 20 will not be given an identification number and password and will be unable to login to the system 10. After agreeing to the terms and conditions 46, the landlord 20 must choose a plan and payment options 48 for using the system 10. The plan and payment options 48, includes all latitude for movement between plan and payment options, and all penalties incurred from doing so. The landlord 20 may upgrade to a higher package at any time and is prompted to do so when attempting to list more properties than his current package allows. Next, the landlord 20 enters their contact information 50, including name and business name, address including city, state, country/province (as necessary) and zip code, phone number including work, home, cellular and pager or beeper, and e-mail address. Lastly, all of the contact information is used to generate a unique identification number and password 52 for the landlord 20.

Once the landlord 20 registers and receives an identification number and password 52, the landlord 20 can bypass the landlord registration component 42 and simply login to the system 10 via the landlord login component 54. Preferably, the landlord interface 40 has various buttons, including those for accessing information about the application, the website, customer care contact, the landlord's 20 account, logout, and messages waiting for the landlord 20, as well as displays, providing information about the current time, the landlord's 20 last login and a welcome message. The landlord interface 40 may also provide the landlord with quick links (specifically, to information on alerts, to access messages, or to view all units and properties listed by the landlord 20), a display of the landlord's unique user identification number, and a search box for searching information on the system 10. Additionally, the landlord interface 40 may include tabs for quick access to other site functions, such as dashboard, unit properties, tenant lists, contacts, accounting, calendar, reports, messaging, tasks, broker information if a broker has signed up for that particular landlord 20, and active/inactive lists. The active/inactive lists provides the landlord 20 with all active or inactive units wherein the landlord 20 can view the rent and lease period term of any unit as well as change the active/inactive status of any particular unit. When a landlord 20 switches a unit from inactive to active, there is an option to immediately add a tenant 22 to that unit.

The landlord interface 40 contains a landlord management tool 56, which allows the landlord 20 to access property listings 12A and tenant listings 12B from the database 18, and preferably allows the landlord 20 to upload the logo of the management company handling all operations for the properties to the site.

The landlord management tool 56 allows the landlord 20 to manage daily tasks, view the landlord's 20 top ten properties based on income from these properties and view charts and graphs such as those displaying information about expense, revenue and profit, or occupancy/vacancy for units, or tenant ratios determined by on time, late or delinquent payments. The landlord management tool 56 allows the landlord to access information stored in contacts, including name, address, phone number, e-mail, and company name, which automatically includes tenants 22 already in the system as well as any manually entered contacts. The landlord 20 may search contacts by first name, last name, phone number or e-mail, and results can be viewed in a pop-up window. Additionally, the landlord management tool 56 preferably has a notes function which acts as an in-page pop up that appears when the landlord 20 chooses to view all notes about a property. In one embodiment, these notes can be viewed as a partial view pop up screen, in which form the landlord 20 is able to manage and control who can edit the information in the Note about a specific property. The landlord management tool 56 also includes a calendar used to manage the lease between the landlord 20 and the tenant 22 which utilizes color codes to indicate lease expiration dates, a task function to manage the daily tasks to be completed at specified times by specified persons which produces a pop-up window on completion of each task, and an account function to create a password-protected personal account with the landlord's 20 personal information including name, address, e-mail, driver's license number, birthday, and bank account information.

Preferably, the landlord interface 40 also includes a messaging system wherein the landlord 20 can send and receive personal messages through the system 10 with a tenant 22, administrator 24 and third party 26. The landlord 20 is able to read messages, search messages, delete messages, and view message information, such as message size, date, and property which the message concerns. In use, the landlord 20 can choose to compose an e-mail to a specific tenant 22, all tenants 22 of a specific property, or all tenants 22 in all of the landlord's 20 properties.

The property listings 12A, contained within the database 18 and accessed by the clients 14, are an organized list of all properties registered into the system 10 by the landlords 20. The landlord. 20 may access the property listings 12A via the landlord management tool 56; and either view 58 all of the vacant and occupied units of the property listings 12A which are currently being managed, including the ability to view and manage past, present, and future expenses for each property, and/or change the property listings 12A by adding or deleting 60 entire properties or specific units with a property. Upon the first login, the landlord 20 will submit any and all property information to be included in the system 10. To add or delete 60 a property, the landlord 20 must submit building information 62, including the name and address of the building including street, city, state, country and province (as necessary) and zip code. Next, the landlord 20 must submit a number of units 64 for each building and individual unit's identification number. Next, the landlord must submit all vacancy information 66 as well as information pertaining to whether tenants reside in the units, whether the units are commercial or residential, the rental price for each unit, the taxes and fees associated with each unit, pictures of the interior and exterior of each unit along with descriptions, disclose any late fees collected by the landlord, the type and style of each unit, number of stories in each unit, the area of the unit, the year the unit was built, and any additional lease or rental conditions. The landlord 20 also has the option of uploading computer files, and photographs, to the system 10 that describe the property. The landlord 20 then clicks submit to submit this information and post the new listing, thereby adding the property listing 12A to the system 10 database 18. The property listings 12A may also be managed and edited by the landlord 20, who can change checkboxes that specify particular features of each unit, such as internet or hardwood floors, as well as change descriptions of each unit and upload new pictures of each unit. The landlord 20 then clicks save to save this information and post the edited listing.

The first time the landlord 20 logs in and enters property information, upon submitting the information, an email 68 will be sent from the system 10 on behalf of the landlord 20 to all of the landlord's tenants. The email 68 will notify the tenants of the new payment remittance system, namely the system 10. The tenant account will not become active with the system 10 until tenant confirmation has been received by the system 10.

The landlord 20 can selectively offer an invitation 75 to join the system 10 to any potential tenant 22 for any and all vacant units. In the preferred embodiment, the invitation 75 is a computer generated email that invites the potential tenant to register for or login to the system 10. The landlord 20 may invite a potential tenant 22 to join the system 10 for a specific vacant unit and instructs the landlord 20 to include information and details about the tenant 22, the unit, and the lease.

The landlord 20 can log into the system 10 and manage property listings 12A. Within the property listings 12A, the landlord 20 may list both single-unit and multiple-unit properties, including information about such properties as accounting details, name of property, type of property, grace periods for lease payment on property, address, number of units, and other provisions regarding each specific property. The landlord 20 may also utilize this function to send and view notes to the tenant 22 of a particular property or unit.

The landlord 20 may find a property or group of properties within the property listings 12A by searching a full or partial property identification number, a full or partial property name, a full or partial address for a property, or a full or partial address for a property. The properties found by the landlord's 20 search are preferably listed with corresponding system 10 property identification numbers, type of property, number of units, name of selected property and address. The landlord 20 may view these properties 58 as sorted by their revenues, expenses, and payment status. Alternatively, the landlord 20 can choose to search for specific properties by specific unit numbers and have the search function return results in a table summarizing details about each property yielded by the search. The landlord 20 may also easily view the current payment status of the specific property returned by the search.

The landlord 20 can access the tenant listings 12B through the landlord management tool 56, which organizes all of the tenants 22 invited to the system 10 by the landlord 20. When the system 10 is correctly used, this list should include all tenants 22 the landlord 20 is currently receiving payment from and any past tenants 22 of the landlord 20. The tenant listings 12B are viewable by tenant payment history or by property address. The tenant payment history within the tenant listing 12B allows the landlord 20 to view the payment history of each tenant 22. The landlord 20 can view tenant information 70, such as current payment status, occupation, address and employment, add or remove tenants 72 from the property, or set, adjust or alter the rental amount and/or rent due date 74. If the landlord 20 is interested in the tenant information 70, the landlord is able to view tenant payment history 76 and then sort this information by tenants with on-time payments 78, which in the preferred embodiment have a green light next to their name, from tenants in default of payment 80. The purpose of this is to alert the landlord 20 to the payment status of the tenant 22. Tenants in default of payment 80 are categorized by those in default 6-28 days 82 and those in default more than 28 days 84. The tenants in default 6-28 days 82, in the preferred embodiment include an amber light next to their name, while those tenants in default over 28 days 84 have a red light next to their name. A tenant 22 that has a history of late rent remittance, along with any and all delinquency, will be reflected in the tenant score 102.

If the landlord 20 is interested in the tenant information 70, the landlord can alternatively choose to access the tenant correspondence tool 86. This will allow the landlord 20 to create, send and. review any and all email correspondence 88 sent to and from the landlord 20 to the tenants 20, including invitations to new tenants 20. The landlord 20 is able to send payment notices 90, including past due or default notifications to tenants 22. The landlord 20 can also set and/or adjust rent amount and rent remittance due dates for tenants 74. In addition, the landlord 20 has the capability to post announcements and comments on a message board that can only be viewed by the tenants 22 of that landlord 20.

Through the tenant listings 12B the landlord 20 can add or remove tenants 72 from the property. Further, the landlord 20 must invite, via an invitation 75 new potential tenants 22 to the system 10, and may list vacant units and properties available for rent free of charge. The tenants 22 provided by the tenant listings 12B can easily be searched by their name, phone number or e-mail address. The result of this search allows the landlord 20 to view tenant information 70, the rent for each unit, tenant payment history 76, and allows the landlord 20 to add or delete tenants 72.

The score listing 12C is contained on the database 18 and accessed by the landlord 20 via the tenant score access component for landlord 104. The score listing 12C organizes the reports and accompanying scores of each tenant 22 invited by a particular landlord 20. The landlord 20 is able to access the tenant rental report 103 with tenant score 102 for a tenant 22. The landlord 20 is able to generate tenant rental reports 103 which can be saved to landlord's 20 account provided the landlord 20 accepts the required terms and conditions. The tenant rental report 103 includes the name of the tenant 22, the tenant score 102, the date on which the report 103 was generated, the date on which the report 103 will expire (preferably 60 days from generation), and a feature that allows the landlord 20 to begin a rent collection process. The landlord 20 can access the tenant score access component for landlord 104 after logging into the landlord login component 54 and entering the landlord interface 40. From the tenant score access component for landlord 104 the landlord is able to research a tenant rental report 103 with tenant score 102, by registering a tenant 106 by submitting a tenant identification number 108, then submitting the tenant score release authorization 110. The system 10 then generates a release number 112, which must be retained by the landlord 20. Then, the landlord 20 is able to search 114 tenant reports by submitting 116 the tenant's name, street address, city, state country/province (as necessary) and zip code, and the release number. If the information, namely the release number and tenant information matches the tenant information given by the tenant 22, the landlord 20 is able to view 118 the tenant report 103 with tenant score 102.

The tenant score access component for landlord 104 also includes a tenant evaluation component 120, which allows landlords 20 to assess the performance of tenants 22 by providing a detailed tenant report 103 and assigning the tenant a tenant score 102. The tenant reports 103 and tenant scores 102 are stored within the score listing 12C contained on the database 18 and may be later accessed by future landlords 20 or authorized third party vendors 26.

In addition, the landlord 20 has the capability to pay mortgages directly through the system 10 to respective mortgage loan companies and to manage the expenses of each rental building. The expense information may then be used by the landlord 20 for tax purposes and to assess the landlord's 20 profit margin line.

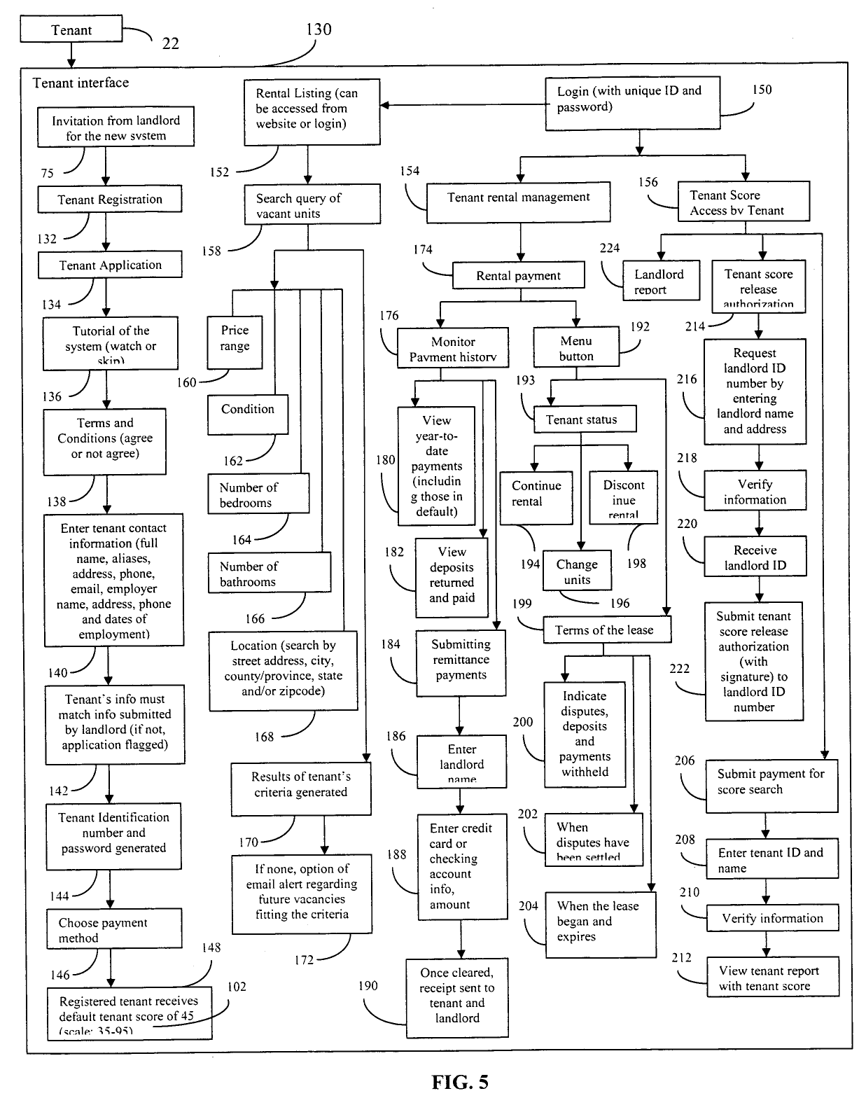

FIG. 5 illustrates the tenant interface 130, which facilitates the transfer of information between the tenant 22 and the server 12. In the preferred embodiment, the tenant 22 is a client 14 that is seeking rental property or a client 14 that is currently behaving in a contractual manner as a tenant, lessee, or renter.

The tenant interface 130 preferably has various buttons, including those for accessing information about the application, the website, contact, the user's account, logout, and messages waiting for the user, as well as displays, providing information about the current time, the user's last login and a welcome message. The tenant interface 130 may also provide the tenant with quick links (specifically, to information on alerts, to access messages, to view all units rented by the tenant or a current calendar), a display of the tenant's unique user identification number, and a search box for searching information on the system 10. Additionally, the tenant interface 130 may include tabs for quick access to other site functions, such as dashboard, rent payment, accounting, reporting, messaging and viewing site listings.

The tenant interface 130 includes the tenant registration component 132 which allows new tenants 22 to register and then begin using the system 10. The tenant 22 will receive an invitation 75 from the landlord 20 to join the system 10. The invitation 75, while preferably via email, may also be sent in the form of a telephone call, ground or air mail. The tenant 22 must receive the invitation 75 to participate in the system 10 from their prospective landlord 20. The invitation 75 includes information about the landlord 20, including name, address and phone number, information about the rent, including amount, due date, late fees, grace periods and lease dates, and tenant contact information 140. Preferably, the email will contain a link that will direct the tenant 22 straight to the tenant registration component 132. The tenant 22 will log on to the system 10 at the tenant registration component 132.

The registration component 132 includes a plurality of different web pages for the tenant 22 to navigate through before an identification number and password is generated to allow the tenant 22 to login. The first page includes a tenant application 134 which must be completed by the potential tenant 22 and submitted. The application 134 may also be completed over the telephone via a telephone representative. The next page of the registration component 132 is a tutorial 136 of the system 10, which the tenant can watch as a video or read as a file. The next page is terms and conditions 138, which the tenant 22 must either agree to or not agree to. If the tenant 22 does not agree to the terms and conditions 138, the tenant 22 will not be given an identification number and password and will be unable to login to the system 10. After agreeing to the terms and conditions 138, the tenant 22 must enter their contact information 140 into the system 10 including their first and last name, all aliases, street address, apartment and unit number (if applicable), city, state, country/province (if applicable) and zip code, telephone number, e-mail address, name of employer, employer's street address, city, state, country/province (if applicable), and zip code, employer's telephone number. In addition, tenant 22 must submit beginning and ending dates of employment, and if the employment is current then indicate such as present. All of the contact information 140 is run through a check screening 142 and compared against information provided by the landlord 20 when the landlord 20 added the tenant 72 in the landlord interface 40. If the contact information 140 matches the information provided by the landlord 20 then the contact information 140 is used to generate a unique identification number and password 144 for the tenant 22. If the contact information 140 does not match the information provided by the landlord 20, the application 134 is flagged for review, and a system 10 representative will clarify the discrepancy.

Once the tenant 22 receives an identification number and password 144, the tenant 22 must choose a payment method 146. The payment method 146 includes pay-by-phone via check-by-phone, debit and/or credit card, online payment via debit and/or credit card, or automatic monthly deduction from a bank account designated by the tenant 22. After selecting a payment method 146, the tenant 22 will receive a completion of registration 148 from the system 10 and an unofficial default tenant score 102 of forty five point zero. The terms and conditions 138 for using the system 10 will also be ground and/or air mailed and e-mailed to the tenant 22.

Once the tenant 22 registers and receives an identification number and password 144, the tenant 22 can bypass the tenant registration component 132 and simply login to the system 10 via the tenant login component 150.

The tenant interface 130 contains a rental listing tool 152 which can be accessed via the web and is viewable by anyone, with or without having to login to the system 10. The tenant interface 130 also contains a tenant rental management tool 154 and a tenant score access component for tenant 156. Preferably, the tenant interface 130 also includes a messaging system wherein the tenant 22 can send and receive personal messages through the system 10 with a landlord 20, administrator 24 and third party 26. The tenant 22 is able to read messages, search messages, delete messages, and view message information, such as message size, date, and property which the message concerns.

Rental listing information for the rental listing tool 152 derives information from the property listing 12A contained on the database 18 and accessed by the tenant 22 via the tenant login component 150, or by anyone in the public via the non-secure tenant interface 130. The rental listing tool 152 organizes all of the rental listing information including properties and corresponding vacant units registered on the system 10 by the landlord 20. The rental listing tool 152 includes a search query tool 158 that accesses the rental listing information for the purpose of allowing tenants 22 to search for vacant units. The search query tool 158 contains field boxes, which enables the tenant 22 to search for vacant units by price range 160, property condition 162, number of bedrooms 164, number of bathrooms 166, and/or property location 168 including street address, city, state, country/province (if applicable), and zip code. The tenant 22 will selectively check off boxes for their desired search and submit the information. The search query tool 158 will generate and display results 170, including vacant units that meet the tenant's search criteria. In the event that the system 10 is unable to immediately generate results that fit the criteria of the tenant 22, the tenant 22 has the option of indicating whether or not they would like to receive an email alert 172 from the system 10, when and if the system 10 receives a vacancy that meets the criteria of the tenant 22.

The tenant rental management tool 154 is included in the tenant interface 130 and allows the tenant 22 to view payment history and rental information. The tenant rental management tool 154 includes a rental payment component 174 for accessing and monitoring the payment history 176 of the tenant 22. When monitoring the payment history 176, the tenant 22 can access information about the landlord, status of the payment, property name, unit name, payment amount and the date on which the payment is made, as well as informative messages sent to the tenant 22 from the landlord 20 or administrator 24. The tenant 22 can view and monitor all year-to-date payments 180, including payments in default, or alternatively view all deposits returned and paid 182.

The tenant rental management tool 154 displays all rentals of the tenant 22, including for each rental the name of the property, name of the unit, rent amount for the unit and name of the manager for the property, along with a link to view information about the landlord 20 of the property, including the landlord's 20 name, address, e-mail and phone number. Any of the rentals of the tenant 22 can be selected in order to display information about that rental, including property name, unit name, unit address, rent, and length of lease by the tenant 22.

In addition, the tenant 22 can submit remittance payments 184 through the system 10. If the tenant 22 is making payments via another method, such as the telephone, the tenant 22 can telephone a system representative and remit payment. If the tenant 22 is remitting payment via the system 10, the tenant 22 can submit remittance payments after logging on through the tenant login component 150 and accessing the rental payment component 174, by entering the name of the landlord 186, entering the checking account or credit card, or bank account information and payment amount 188 and submitting it to the system 10. The funds are thereby transferred from the designated account for the tenant 22 to the designated account for the landlord 20. Once payment clears, a receipt email 190 is generated by the system 10 and sent to both the tenant 22 and landlord 20. Through the rental payment component 174 the tenant can also view unit information, preferably including property name, security deposit, maintenance fees, payment due dates, automatic late fees if payments are past due and total amounts to be paid by tenant 22.

The tenant 22 also has the capability to manage their account by viewing their rental expenses, including maintenance, gas, electricity, heat, and water utility payments, and/or cable payments. The tenant 22 may also add, edit and delete information regarding expenses for the unit, including the amount of each expense and payment information for each expense. The tenant may also view expense payment information for any month or year up to the last four years.

Additionally, the tenant 22 can use a menu button 192 to make a plurality of different indications about either tenant status 193 or the terms of the lease 199. First under tenant status 193, whether or not they would like to continue renting 194 the particular unit from the respective landlord 20, whether or not they would like to rent a different unit 196 from their current landlord 20, and/or whether not they would like to discontinue the rental agreement 198 with their current landlord 20. Second, under terms of the lease 199, the tenant 22 can indicate any and all disputes with regards to deposits and payments withheld 200, and when any and all disputes with regards to deposits and payments withheld have been settled 202. This indication, if selected, includes a disclaimer disclosure to please refer to the laws in your respective state and country for lease and/or rental information, and with respect to any and all disputes which result from such actions. Last, the tenant 22 shall indicate when the lease began and when the lease is said to expire 204. Although the rental lease is not executed under the system 10, the terms of the lease 199 allows the tenant 22 to view all of the terms and conditions of the lease previously agreed upon by the landlord 20 and tenant 22.

In addition, the tenant score access component for tenant 156 is accessible by the tenant 22 through the tenant interface 130, after logging in through the tenant login component 150. First, the tenant 22 is required to remit payment 206 for accessing their own tenant score 102. Once payment is submitted to the system 10, tenant 22 must provide the tenant's individual identification number and their first and last name 208. If the information entered checks out to be accurate 210 and matches information within the database 18, then the tenant will receive 212 their tenant score 102 and tenant score report 103 by preferred method.

Lastly, the tenant score 102 and tenant report 103 remain confidential until the tenant 22 gives authorization 214 to the landlord 20 to view them. To give authorization 214, the tenant 22 will request the landlord's identification number 216 by submitting the landlord's name and street address including city, state, country/province (if applicable) and zip code. If the information checks out and is accurate 218, the tenant 22 will receive 220 the identification number. Lastly, tenant 22 will submit a standard release 222 with signature of the tenant 22 thereon, such that landlord 20 is able to perform a tenant score search to receive the tenant score 102.

The tenant 22 is able to set the search account to perform automatic searches, enabling all indicated landlords to perform the tenant score search 114 without the tenant's signature for each and every one. Such authorization may be granted upon tenant's initial submission of the automatic search feature. Such feature is useful in the event that the tenant is searching and/or applying for more than one unit.

The tenant score access component for tenant 156 also includes a landlord evaluation component 224, which allows tenants 22 to assess the performance of landlords by providing a detailed final report of the tenant's landlord 20. Such landlord reports 105 are stored within the score listing 12C contained on the database 18 and may be later accessed by future tenants 22.

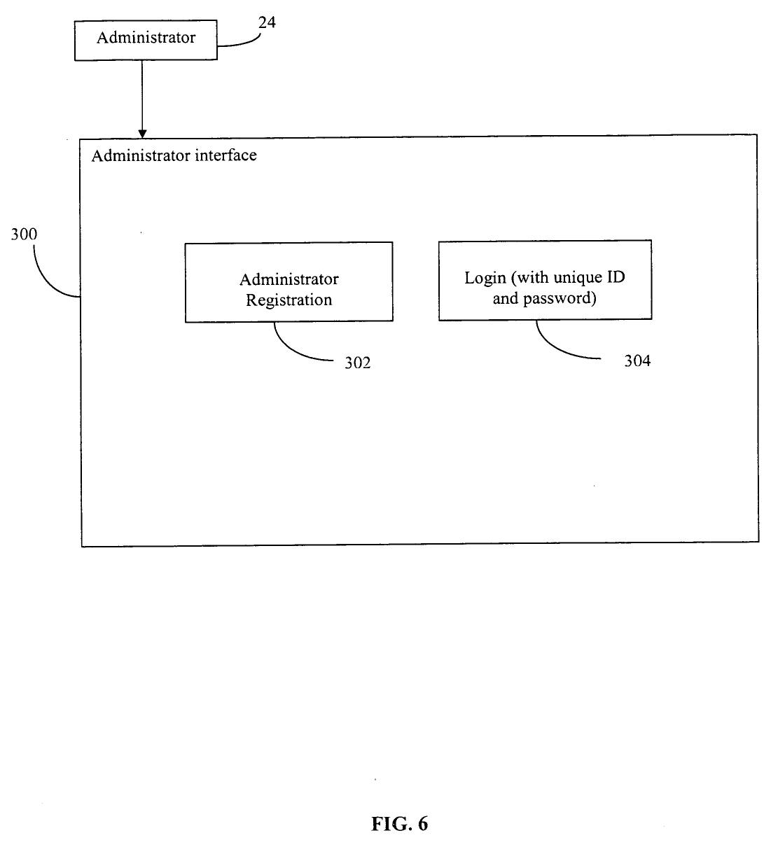

FIG. 6 illustrates the administrative interface 300, which facilitates the transfer of information between the administrator 24 and the server 12. In the preferred embodiment, the administrator 24 includes any management officer given permission and access to view, login, manage, debug, improve or maintain the system 10. The administrator 24 would have the administrative registration component 302 within the administrative interface 300, administrator login component 304, as well as access to all information pertaining to the landlord 20, tenant 22 and third party vendor 26.

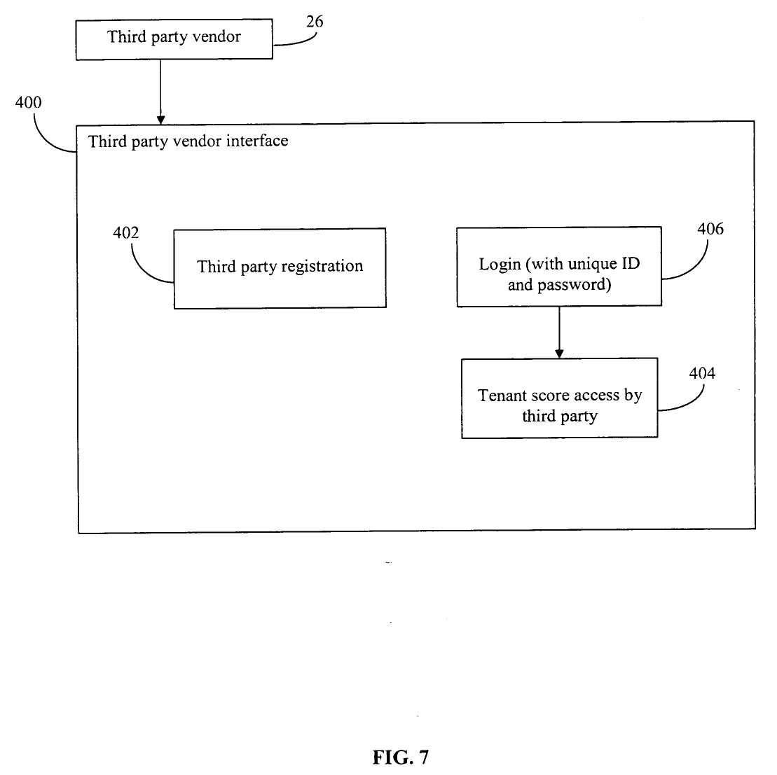

FIG. 7 illustrates the third party interface 400, which facilitates the transfer of information between the third party vendor 26 and the server 12. In the preferred embodiment, the third party vendor 26 includes any business, mortgage company, complex developer, broker, realtor and management company that may have a professional interest in accessing a tenant score 102. The third party vendor 26 would have the third party registration component 402 within the third party interface 400, as well as a third party vendor login component 406 and tenant score access for third parties 404. Third party vendors 26 have similar registration requirements. Similar to access by the landlord 20, the third party vendor 26 would need permission from the tenant to access tenant score 102. The third party vendor 26 is also permitted to view tables detailing recent transactions related to a certain landlord 20 or particular property, landlord 20 searches, charts detailing customer books, and income summaries including quarterly sales, commissions, and payout dates. Third party vendors 26 also have the ability to send and receive messages through the system 10, wherein the third party vendor 26 can search for a landlord 20 to send a message to, search for a property in a landlord's 20 portfolio and message one or more of the tenants living there, and send a message to a landlord 20, a particular tenant 22, or the administrator 24.

In addition, the third party vendor 28 and landlord 20 have the capability to export all data and management information gathered from their unique system, to the server 12 of the present invention. Alternatively, the server 12 of the present system 10 can import the data automatically. The system 10 of the present invention can convert this import and then analyze the information in order to supplement the tenant score 102 and tenant report 103 of each tenant for which the management company has data for.

In conclusion, herein is presented an online system and method for users to conduct property rental transactions and property management, while simultaneously assessing the performance of landlords and tenants in an online environment. The invention is illustrated by example in the drawing figures, and throughout the written description. It should be understood that numerous variations are possible, while adhering to the inventive concept. Such variations are contemplated as being a part of the present invention.

What is claimed is:

1. An online system for conducting property rental transactions and property management, while simultaneously assessing performance of landlords and tenants, the system comprising:
a client-server module in communication with a plurality of clients by means of a online network, said client-server module for facilitating leasing transactions over said online network, wherein said clients including a plurality of landlords, tenants, administrators, and third party vendors act as request senders requesting data and waiting for a reply;
a server;
a database configured in communication with said server for collecting, storing and retrieving information from said server upon request from said clients and providing data to said clients based on said request, wherein said database contains a plurality of records, including, property listings, tenant listings and score listings, wherein said tenant listings include an organized list of all properties registered by landlords, and said score listings include tenant reports, tenant scores created by said landlords, and landlord reports created by said tenants;
wherein said server configured in communication with the database, and including a plurality of interfaces including a main user interface, a landlord interface, a tenant interface, an administrator interface, and a third party interface, wherein said interfaces of said server facilitate communications between said server and said clients;
a main user interface for facilitating transfer of information between said client and said server, wherein said main user interface includes a registration tool, a login tool and a tenant score tool, wherein said main user interface allows said client to access the registration tool, login tool or tenant score tool, and then directs said client to the appropriate interface, including landlord interface, tenant interface, administrator interface, or third party interface;
wherein said registration tool allows new clients to use said system and is in communication with a landlord registration component within the landlord interface, a tenant registration component within the tenant interface, a third party registration component within the third party interface, and an administrator registration component within the administrator interface, and said registration tool includes a security component for ensuring privacy of information provided, wherein said login tool allows said clients to use said system and is in communication with the landlord login component, the tenant login component, the administrator login component, and the third party vendor login component, wherein said login tool receives a unique identification number and password entered by said client, and through said unique identification number and password immediately recognizes whether the client is a landlord, tenant, administrator, or third party vendor and thereby automatically directs said client to their corresponding interface allowing access to secure features of said interface, landlords to said landlord interface, tenants to said tenant interface, administrators to said administrator interface and third party vendors to said third party vendor interface, and wherein said login tool includes a security component for ensuring privacy of all information provided; and
wherein the landlord interface comprises:
a landlord registration component which allows landlords to register and then begin using the system, said landlord registration component includes a plurality of different web pages for said landlord to navigate through before automatically generating a unique identification number and password for direct login to said landlord login component;
a landlord login component which bypasses said landlord registration component and allows landlords direct login access to the landlord interface with said unique identification number and password;
a landlord management tool for viewing, adding, deleting or changing property listings registered by said landlord and viewing and organizing tenant listings, said tenant listings include viewing tenants by payment history or property address, and viewing tenant information and payment history including on-time payments, late payments and defaults, and adjusting or altering rental amounts and payment due dates, and wherein said landlord management tool allows landlords to selectively offer an invitation to tenants to lease a particular unit by joining the system by sending a computer generated email to tenants from said landlord with instructions and a link for registering to join the system; and
a tenant correspondence tool for creating, sending, reviewing and tracking email between said landlord and tenant, including invitation to join the system, payment notices and default notifications, and message board comments;
wherein the tenant interface comprises; and
a tenant registration component which allows said tenants to register before using said system, and is accessible by said tenants by clicking said link received in said computer generated email invitation sent from said landlord, said registration component includes a plurality of different web pages for said tenant to navigate through which is screened and cross-reference with information provided by said landlord before automatically generating a unique identification number and password;
a tenant login component which bypasses said tenant registration component and allows said tenants direct login access to said tenant interface with said unique identification number and password;
a rental listing tool for searching vacant units and publishing available rental units including rental price, condition of dwelling, number of bedrooms, location, said rental listing tool includes a search query tool and email alerts regarding future vacancies; and
a tenant management tool for viewing payment history and rental information, said tenant management tool including a rental payment component for paying rent directly through said system and sending a receipt to said tenant and landlord after payment has cleared, and for accessing and monitoring payment history including year-to-date payments, payments in default, or all deposits returned and paid, said tenant management tool includes a menu button for viewing a plurality of different indications of tenant status and leasing terms;
a tenant score tool for allowing said client to access a tenant rental report and tenant score listing from said database via a tenant score access component for landlord, tenant score access component for tenants, and tenant score access component for third parties, where said tenant score is a numerical digit, uniquely generated through a plurality of compiled data, ranging from thirty five point zero to ninety five point zero, wherein said tenant score tool including a security component for ensuring privacy of all information provided, wherein the tenant score tool for said landlord is accessed after entering the landlord interface and providing contact information for said tenant, including a tenant identification number and a tenant score release authorization number, provided when all contact information entered matches that entered by said tenant, for allowing the landlord access to the tenant report and accompanying tenant score for each said tenant invited by said landlord, said landlord generates and saves tenant rental reports which include name of the tenant, the tenant score, the date on which the report was generated, the date on which the report expires and a feature for instituting rent collection process, the tenant score access component for said landlord also including a tenant evaluation component for allowing said landlords to assess performance of said tenants by providing a detailed tenant report and assigning said tenant a tenant score and the tenant reports and tenant scores are stored within the score listing contained on said database for future viewing by said landlords or third party vendors, wherein said tenant score access component for said tenant is accessible by said tenant through said tenant interface after logging in through said tenant login component and remitting required payment, said tenant provides their identification number and name, and upon cross-reference receives said tenant score and said tenant score report, said tenant score and aid tenant score report remain confidential until said tenant authorizes said landlord to view them by requesting the landlord's identification number and submitting the landlord's name and street address including city, state, country/province and zip code, and upon cross-reference, said tenant receives an identification number, and wherein said tenant submits a standard release with signature for allowing at least one landlord to perform a tenant score search, and wherein said tenant score access component for tenant also includes a landlord evaluation component, which allows tenants to assess performance of said landlords by providing a detailed final report which is stored within said score listing contained on said database and is accessible by future tenants.

2. The online system of claim 1, wherein the server is a World Wide Web server.

3. The online system of claim 1, wherein the tenant score includes a default score of forty five point zero assigned to all tenants automatically upon first login in to the system.

4. The online system of claim 1, wherein a first page of the landlord registration component includes a landlord application for completion and submission by the landlord, wherein a next page of the landlord registration component is a tutorial of the system, watched as a video or read as a file, wherein the next page is terms and conditions which must be agreed to by the landlord before an identification number and password are generated for automatic login to the system, wherein a next page includes service plans and payment options including all latitude for movement between plan and payment options and all penalties, wherein a next page includes landlord entering contact information, including name and business name, address including city, state, country/province and zip code, phone number including work, home, cellular and pager or beeper, and e-mail address.

5. The online system of claim 1, wherein a first page of the tenant registration component includes a tenant application for completion and submission by the tenant, wherein a next page of the tenant registration component is a tutorial of the system, watches as a video or read as a file, wherein the next page is terms and conditions which must be agreed to by the tenant before an identification number and password are generated for automatic login to the system, wherein the next step of the tenant registration component the tenant must enter contact information including name and business name, address including city, state, country/province and zip code, phone number including work, home, cellular and pager or beeper, e-mail address, employer information, dates of employment, and all of which is all screened and cross-referenced with information provided by the landlord and upon adequate matching with information provided by the landlord through the landlord, the next step of the tenant registration component includes choosing a payment method including pay-by-phone via check-by-phone, debit or credit card, online payment via debit, credit card or electronic funds transfer, or automatic monthly withdrawal from a bank account.

6. The online system of claim 1, wherein the landlord interface includes a component for paying mortgage payments through the system to respective mortgage loan companies and manages expenses incurred by the landlord for each rental building.

7. The online system of claim 1, wherein the rental payment component accepts online payments to the landlord tenant for credit to the landlord using a checking account or credit card account and payment amount.

8. The online system of claim 1, wherein the tenant management tool includes a means for the tenant to view rental expenses, maintenance, gas, electricity, heat and water utility and cable payments.

9. The online system of claim 1, wherein the tenant status accessed by the menu button within the tenant rental management tool include options for renewing a lease, moving to a different unit owned by the same landlord, discontinuing the lease, and wherein terms of the lease accessed by the menu button within the tenant rental management tool includes fields for documenting disputes with regards to deposits and payments withheld, settlements, beginning and ending dates of the lease, and terms and conditions of the lease.

10. The online system of claim 1, wherein the third party interface includes allowing access to a tenant score to businesses, mortgage companies, complex developers, realtors, management companies and brokers, includes messaging capabilities between the third party vendors and tenants, landlords and administrators, and includes access to searching available property listings.

11. The online system of claim 1, wherein the administrative interface includes allowing an administrator permission and access to view, login, manage, debug, improve or maintain the system, as well as access all information pertaining to the landlord, tenant and third party vendor, and includes messaging capabilities between the administrator and third party vendors, tenants and landlords.

12. A method for landlords to manage property listings and tenant listings using an online system including a landlord interface and a landlord management tool in communication with a database and a server, the steps comprising:
a. registering for said system using a landlord registration component and receiving a unique identification number and password;
b. logging in to said landlord interface by entering said unique identification number and password;
c. adding properties to said system by inputting unit and building information;
d. sending a computer generated email to a tenant with instructions and a link to register and join the system and lease a specific rental unit;
e. managing property listings including viewing vacant and occupied units;
f. managing tenant payments by viewing tenant listings, tenant information, tenant payments, default payments, expenses, revenues, profits;
g. managing tenant correspondence by sending and receiving emails, payment notices, postings to message boards, and invitations to new tenants to join the system;
h. corresponding with administrators and third party vendors;
i. viewing, editing and adding reminder notes which automatically pop up on the system;
j. tracking deadlines and events by an online color coded calendar;
k. accessing, searching and viewing tenant score by registering a tenant and submitting a tenant; and identification number and authorization release; and
l. creating a tenant report and assigning a tenant score for tenants occupying landlord units.

13. The method for landlords to manage property listings and tenant listings of claim 12, the steps further comprising repeating steps b. every time, followed by repeating steps c. through i. in alternating order.

14. The method for landlords to manage property listings and tenant listings of claim 12, the steps further comprising paying mortgage payments to mortgage loan companies and managing expenses incurred by the landlord for each rental building directly through the system using a checking account.

15. The method for landlords to manage property listings and tenant listings of claim 12, the steps further comprising receiving rent payments from tenants directly through the system into a predetermined-checking account.

16. A method for tenants to manage occupancy in a rental unit using an online system including a tenant interface and a tenant management tool in communication with a database and a server, the steps comprising:
a. receiving a computer generated email invitation from a landlord to lease a rental unit by joining the system;
b. redirecting the tenant to the system by clicking on a link in the invitation email;
c. registering for said system using a tenant registration component and receiving a unique identification number and password;
d. logging in to said tenant interface by entering said unique identification number and password;
e. tracking payment and lease deadlines and events by an online color coded calendar;
f. managing rental payments by sending a rental payment directly to the landlord through the system by using a credit card or checking account;
g. receiving a receipt that said rental payment was received by the landlord;
h. managing tenant status by selecting a menu button option and renewing or discontinuing the lease, disputing deposits or payments, viewing lease terms;
i. managing correspondence by sending and receiving emails to the landlord, administrator, and third party vendors, and making postings to message boards; and
j. accessing, searching and viewing tenant score by authorizing release of information to the landlord by requesting landlord identification number and verifying information.

17. The method for tenants to manage occupancy in a rental unit of claim 16, the steps further comprising, searching a plurality of available rental units by a plurality of query options.

18. The method for tenants to manage occupancy in a rental unit of claim 16, the steps further comprising, updating tenant score and tenant report each time landlord evaluates tenant.

19. The method for tenants to manage occupancy in a rental unit of claim 16, the steps further comprising, assessing performance of the landlord by providing a detailed final report for storage within said score listing contained on said database and accessible by future tenants.
